(19) United States
(12) Patent Application Publication
(10) Pub. No.: US 2024/0076007 A1
(43) Pub. Date: Mar. 7, 2024

(54) ADJUSTABLE HEIGHT OR DROPPER SEATPOST FOR BICYCLE

(71) Applicant: Crank Brothers, Inc., Laguna Beach, CA (US)

(72) Inventors: Carl Winefordner, Laguna Beach, CA (US); Frank Hermansen, Laguna Beach, CA (US); Jeremiah Starkey, Laguna Beach, CA (US)

(21) Appl. No.: 17/903,386

(22) Filed: Sep. 6, 2022

(51) Int. Cl. B62K 19/36; B62J 1/06

(52) U.S. Cl. CPC B62K 19/36; B62J 1/065

(57) ABSTRACT

The present invention relates to an adjustable height or dropper seatpost for a bicycle.

### TECHNICAL FIELD OF THE INVENTION

The present invention relates to an adjustable height or dropper seatpost for a bicycle as well as a bicycle.

### STATE OF THE ART

Remote control height adjustable bicycle seatposts are now common on the market because they allow riders to easily adjust the height of their saddle during a ride, particularly during mountain biking, but also for other bicycling types including road, gravel, and cyclocross.

Typical adjustable height seatposts require a cable and cable housing that starts at the seatpost and ends at a handlebar mounted lever or button. Recent trends are requiring the most amount of seatpost travel to be accomplished in the shortest overall axial length. In addition to short overall axial length, current market trends are for longer travel and adjustable travel limits.

Most adjustable height seatposts today use a gas spring located in line with a hydraulic chamber. The gas spring is compressed as the seatpost is lowered. The compression of the gas is what generates the spring force when the seatpost is required to return to full height. A valve operated by the user controls the flow of the hydraulic fluid. When this valve is open, the seatpost can move. When the valve closed the seatpost is held in place via the sealed hydraulic fluid chamber. This embodiment requires an addition in length due to the gas chamber being placed inline axially with the hydraulic chamber. It also makes it difficult to achieve the desired low gas spring forces in longer travel variations due to the limited available axial space. By minimizing the volume of the hydraulic chamber, gas pressure rises sharply between fully extended and fully compressed causing the spring force to also rise sharply. In all current embodiments of this style the valve is actuated through the travel rod. This requires the travel rod to be hollow and larger diameter in order to accommodate the actuation rod. The large diameter hollow travel rod adds to the axial length, increases the part cost and reduces the strength of the travel rod. This extra cartridge length often causes the adjustable seatpost to be so long that it does not fit in some bicycle frames.

A “TwinTube” design fundamentally differs from an inline design by placing the gas spring chamber on the outside of the hydraulic chamber as opposed to on top of it. By using the TwinTube design no additional length is added in line with the hydraulic chamber. This allows for a much shorter overall axial length.

Gas spring force changes achieved are also much lower due to the larger gas spring chamber volume that can be accommodated and the relatively small change in displacement caused by the travel rod change in travel. Since most of the force required to drop the seatpost is due to the gas spring pressure, it is highly desirable to reduce the gas spring pressure ramp up and corresponding seatpost drop force.

The TwinTube design also allows for a smaller cartridge diameter design vs the inline system. This creates more room between the cartridge outer diameter and the seatpost body inner diameter which can be used for more material increasing strength and allowing for longer travel options.

Requirements for adjustable travel limiting are becoming more common in the marketplace. This requirement allows riders to achieve the maximum amount of travel that can be accommodated by their saddle height and frame geometry. Current embodiments require a spacer of either radial or axial orientation that must be carefully removed and aligned in order to achieve the desired travel limit adjustment. In other embodiments, spacers must be added or subtracted from the system. This allows for pieces to be lost and is a greater risk for contamination of the system. It also can be a complex operation for the end user.

### SUMMARY OF THE INVENTION

An object of the present invention is to provide a new adjustable height or dropper seatpost for a bicycle.

Another object of the present invention is to provide a seatpost, which has a strength greater than known seatposts, but is cheaper than the latter.

Another object of the present invention is to provide a seatpost with a cartridge including oil and gas, in which the displacement volume is reduced.

Another object of the present invention is to provide a seatpost with a smaller volume travel rod.

Another object of the present invention is to provide a seatpost with a weight lower than seatposts taught so far.

Another object of the present invention is to provide a seatpost with a travel limit adjustment system, which does not need to add/remove parts, and that does not incur in orientation changes, thereby improving the simplicity of adjustment.

Another object of the present invention is to provide a seatpost with a connection for the cable suitable for reducing the overall length to accommodate the cable end mounting point.

According to the present invention a seatpost as per the present application is proposed.

The present application refers to preferred and advantageous embodiments of the invention.

### BRIEF DESCRIPTION OF THE DRAWINGS

These and other advantages will be better understood by any man skilled in the art from the following description and from the attached drawings, given as a non-limiting example, in which:

FIG. 1 shows an adjustable height seatpost for a bicycle in accordance with the present invention,

FIG. 2 is a cross-section view of the seatpost of FIG. 1;

FIG. 3 is a detail in an enlarged scale of FIG. 2 at the lower end of the seatpost,

FIG. 4 is a cross section view similar to FIG. 3 with the actuator mechanism actuated,

FIG. 5 is a perspective view of some components assembled of the seatpost of FIG. 1;

FIGS. 6 and 7 are perspective views from respective sides of a valve body of the seatpost of FIG. 1;

FIGS. 8 and 9 are perspective views from respective sides of a shutter or poppet valve of the seatpost of FIG. 1;

FIGS. 10 and 11 are perspective views from respective sides of a seal component of the seatpost of FIG. 1;

FIG. 12 is a detail in an enlarged scale of FIG. 2 at the intermediate or medial portion of the seatpost,

FIG. 13 shows some components assembled of the seatpost of FIG. 1 at the intermediate or medial portion of the seatpost;

FIGS. 14 and 15 show the travel limiting device or unit for adjusting of the seatpost of FIG. 1 in maximum seatpost travel and minimal seatpost travel;

FIGS. 16, 17 and 18 are perspective views from respective sides of the lower end of the seatpost of FIG. 1;

FIG. 19 is a cross-section view of the seatpost of FIG. 1 focused on the actuator mechanism; and

FIG. 20 is a schematic view of a bicycle according to the present invention with a lever and a cable for controlling an actuator mechanism of an adjustable height seatpost.

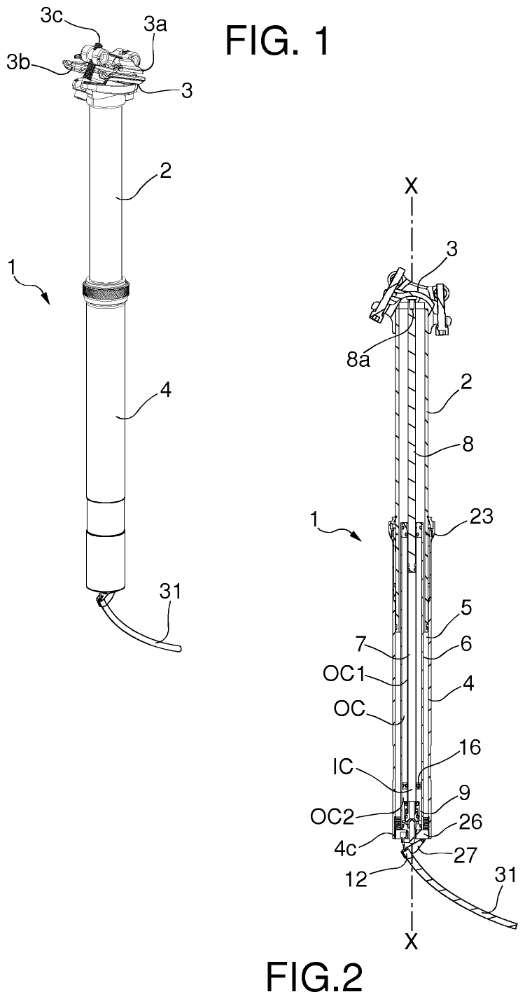

### DETAILED DESCRIPTION OF THE INVENTION

The present invention relates to an adjustable height or dropper seatpost 1 for a bicycle including an upper, in use, tube 2, seat clamps or connector 3 for connecting the seatpost 1 to a bicycle seat or saddle SA, which seat clamps or connector 3 are supported by and integral in vertical translation with the upper tube 2.

The seat clamps or connector 3 can be structured and connected or fitted to the upper tube 2 in any suitable manner. In this respect, they can include a pair of clamps or jaws 3a. 3b with means for approaching or moving apart 3c the clamps or jaws, such as screws, bolts or the like. The seat clamps or connector 3 can define one or two housing for receiving and clamping, owing to the action of the means for approaching or moving apart 3c, the fork of a bicycle seat or saddle SA or the prongs thereof.

Moreover, the seatpost 1 includes a lower, in use, tube 4, with the upper tube 2 being slidingly mounted (and preferably coaxially mounted) in the lower tube 4 or vice versa along an axis x-x (see FIG. 2).

In this respect, the upper 2 and lower 4 tube are preferably shaped as a solid of rotation around an axis of symmetry, which axis corresponds to the axis x-x.

Another component of the seatpost 1 is a cartridge 5 mounted inside the upper 2 and lower 4 tubes, which cartridge 5 has an outer tube 6 and an inner tube 7 coaxially mounted inside the outer tube 6. The outer 6 and inner 7 tubes are preferably shaped as a solid of rotation around an axis of symmetry, which axis corresponds to the axis x-x.

The cartridge 5 further comprises a plunger rod 8, preferably solid, i.e. not hollow, slidingly mounted inside the inner tube 7 with an upper, in use, end 8a of the plunger rod 8 or an upper, in use, end of the outer tube (if the cartridge 5 is mounted in a reversed manner) connected, in any suitable manner to the seat clamps or connector 3 and integral in vertical translation therewith.

The cartridge 5 could be even mounted in a manner reversed (top-bottom) with respect to that shown in the figure, i.e. with the tip of the plunger rod 8 mounted at the lower end of the seatpost or rather at the lower end of the lower tube 4.

In this respect, if, for some reason, the desired valve location was at the top of the post, it would be easy to invert the cartridge 5.

Thus, even if the description is mainly based on the arrangement shown in the figures, a reverse position of the cartridge 5 should be considered as included in the patent scope.

If desired, the plunger rod 8 can delimit one or more gaps, for example annular gaps for housing respective one or more gaskets or the like.

As it will be understood, the seatpost 1 is installed in a tubular component TC of a bicycle frame FR, which could have a respective longitudinal axis vertical or slightly inclined with respect to the vertical, and thus the seatpost 1 could be, in use, substantially vertical or slightly inclined with respect to the vertical, although, in an attempt to render the present description more manageable, we will refer to the term “vertical” only, although the “slightly inclined” option should be considered as included in the scope of this patent document.

Furthermore, the cartridge 5 defines an outer chamber OC between the outer tube 6 and the inner tube 7 filled in at a respective first or upper part OC1 with gas, for example compressed air or gas, and at a respective second or lower part OC2 with fluid or oil, such as an hydraulic oil and an inner chamber IC adjustably defined at the second or lower part of the inner tube 7 as a function of the position of the plunger rod 8. The inner chamber IC is filled in with fluid or oil as the second or lower part OC2 of the outer chamber OC.

The cartridge 5 is even provided with a valve unit 9 arranged to close/open the fluid communication among the outer chamber OC and the inner chamber IC, and preferably with seal components or heads 10, 11 mounted in the upper 6a and lower end 6b of the outer tube 6.

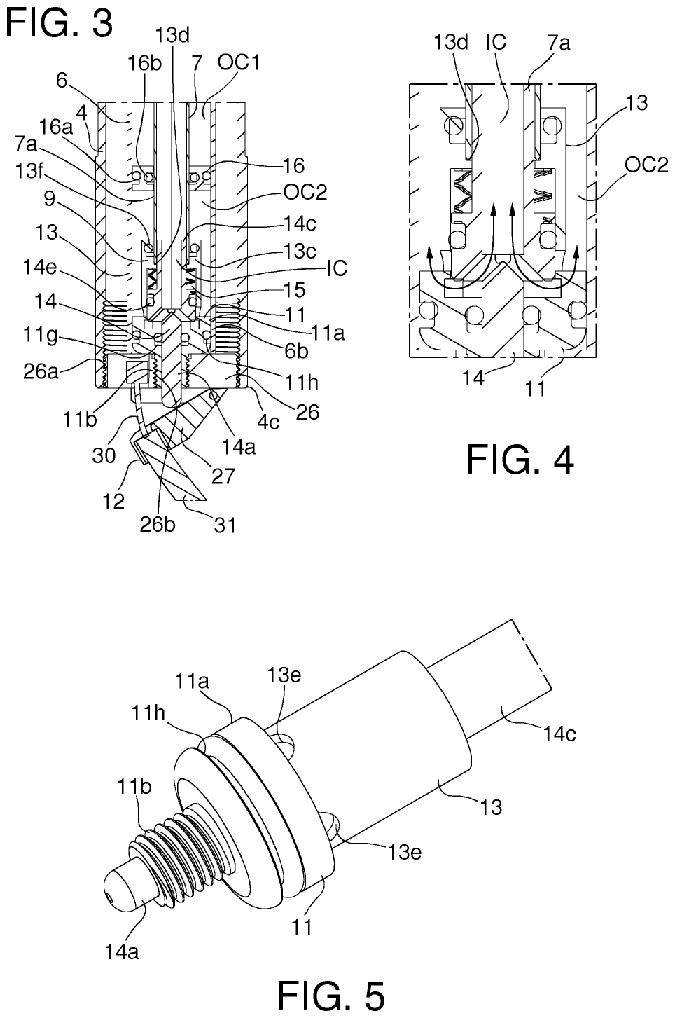

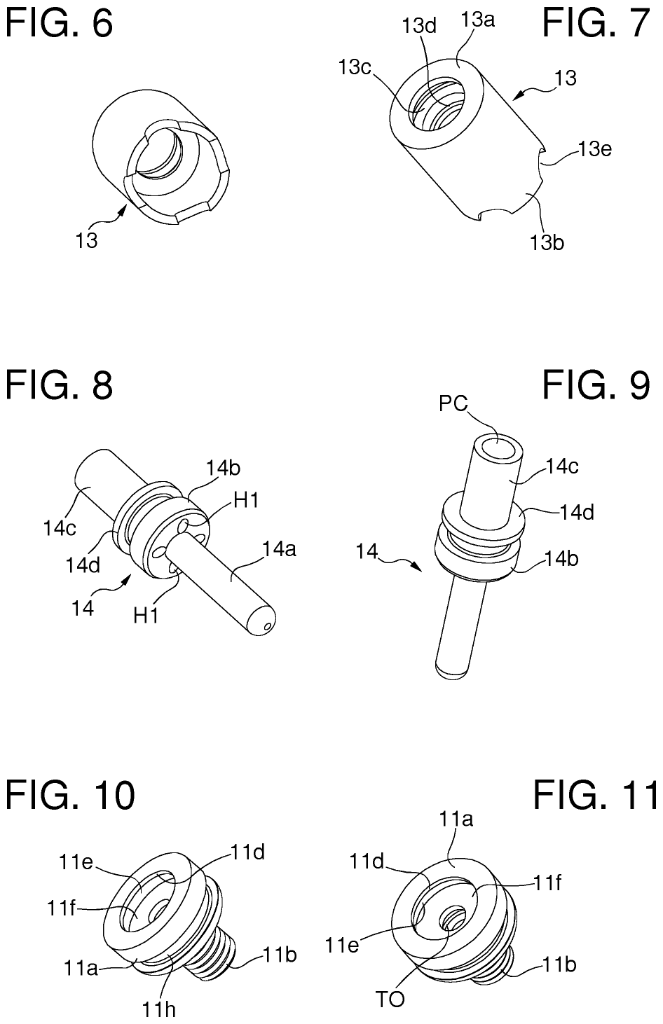

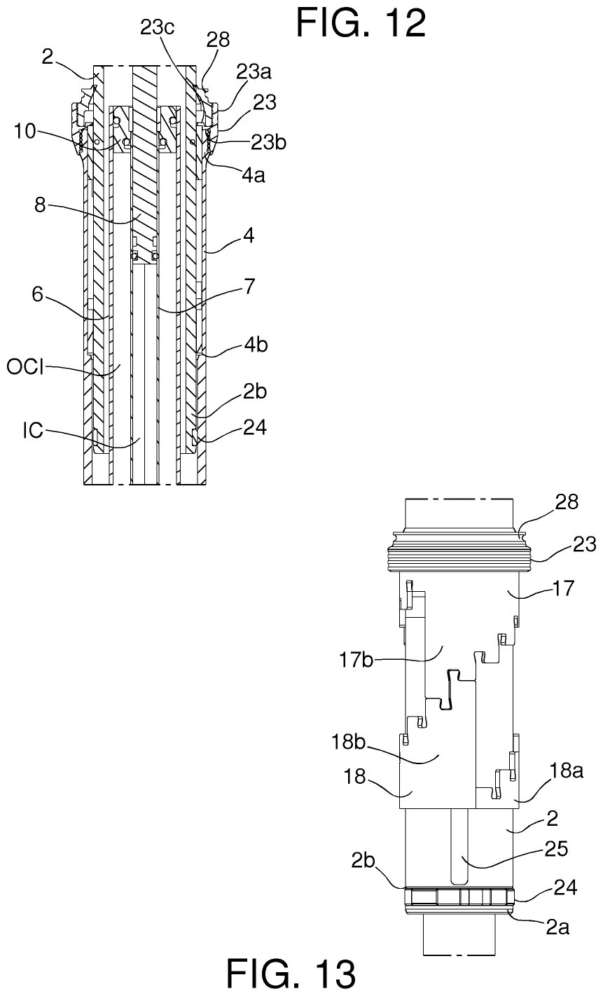

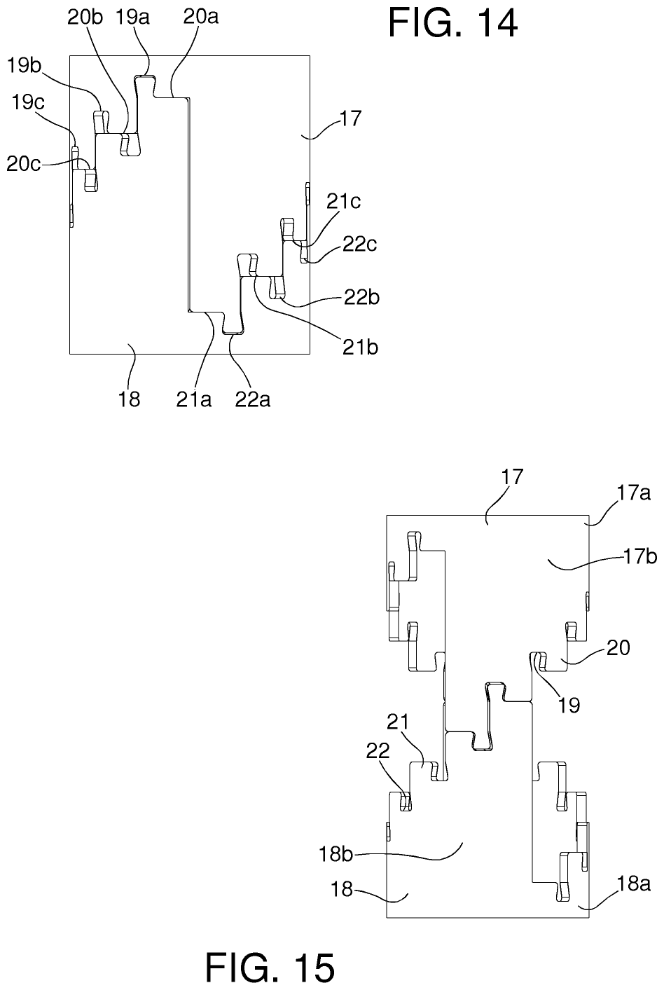

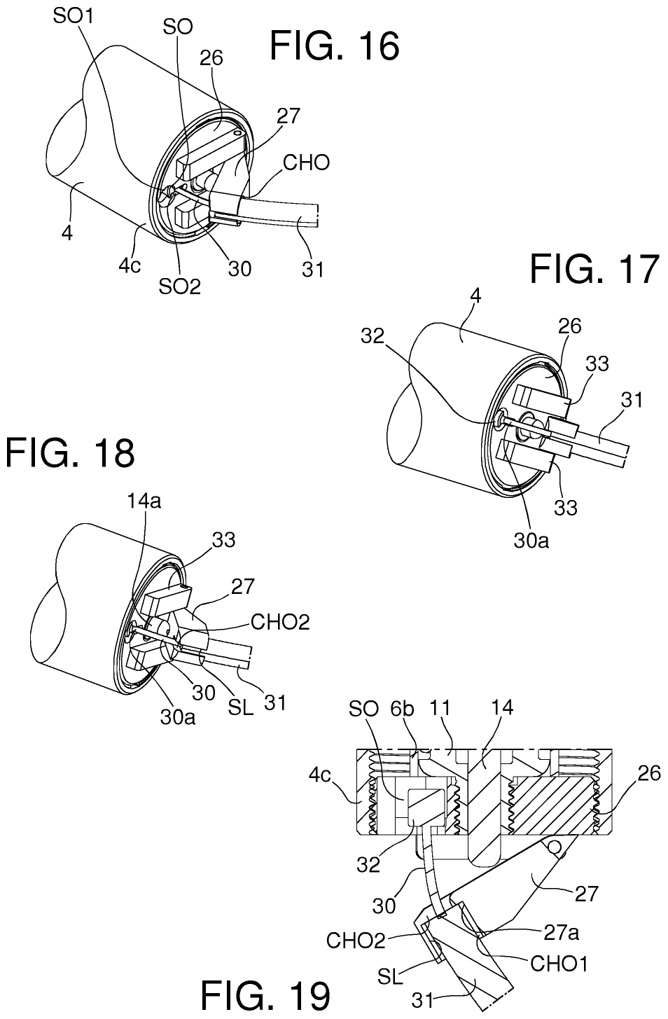

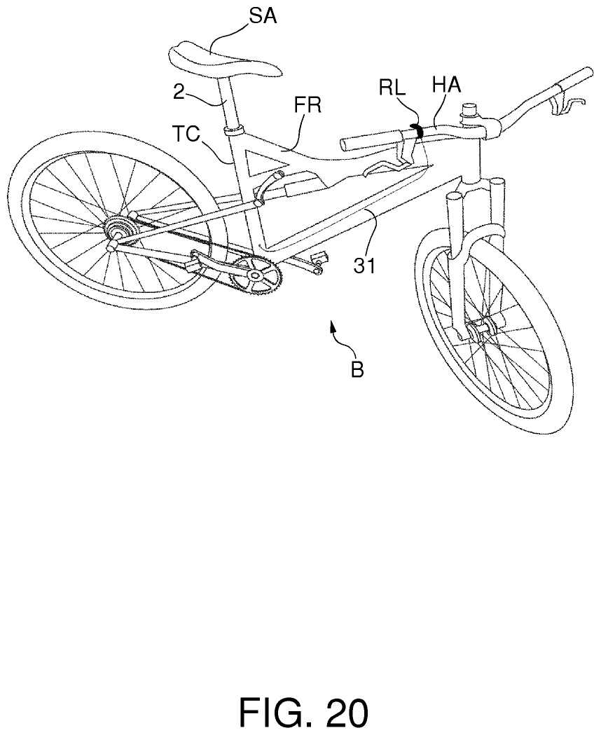

The seatpost 1 further includes an actuator mechanism 12, for example mounted at the lower, in use, end 6b of the outer tube 6 and arranged to open/close the valve unit 9, so that when the actuator mechanism 12 is in a closed position (see in particular FIG. 3), the fluid communication among the inner chamber IC and outer chamber OC or rather the second or lower part OC2 thereof is prevented, the length of the seatpost 1 is locked and the fluid or hydraulic oil contained in the inner chamber IC supports the plunger rod 8, and, in turn, a rider's weight.

When instead the actuator mechanism 12 is in an open position (see in particular FIG. 4), it opens the fluid communication among the inner chamber IC and the outer chamber OC, thereby the fluid or oil can flow among such chambers IC, OC, so that, as a function of the force or load applied to the seat clamps or connector 3, i.e. to the overlying seat or saddle SA, it is possible to vary or adjust the position of the plunger rod 8 inside the inner tube 7 and, in turn, the height of the seatpost 1.

The actuator mechanism 12 could also be linked to the valve unit 9 via an intermediary part like a lever or pushing rod.

Moreover, the actuator mechanism 12 could be adapted to be electronically controlled.

Advantageously or in accordance with a first preferred and not limitative aspect of the present invention, the valve unit 9 comprises a valve body or valve housing 13 mounted at the lower end 7a or upper end (if the cartridge 5 is mounted in a reverse manner) of the inner tube 7, as well as a shutter component 14 slidingly mounted in the lower end 6b or upper end 6a (if the cartridge is mounted in a reverse manner) of the outer tube 6 or in a seal component 11 mounted therein and engageable by the actuator mechanism 12 for opening/closing the valve unit 9.

The shutter component 14 is for example mounted movable, by means of the actuator mechanism 12, among a raised position (see FIG. 4) and a lowered (see FIG. 3) position with respect to the inner tube 7 and with respect to the lower end 6b or upper end 6a of the outer tube 6, so that when the actuator mechanism 12 is in a closed position, the shutter component 14 is lowered or raised (if the cartridge 5 is mounted in a reverse manner) and sealingly abutted against the lower end 6b or upper end 6a of the outer tube 6 or against a seal component 11 mounted therein, so that the fluid communication among the inner chamber IC and outer chamber OC (or rather the lower part OC2 thereof) is prevented, whereas when the actuator mechanism 12 is in an open position, it pushes or acts (directly or with the interposition of other components) on the shutter component 14 and brings the same to a raised or lowered (if the cartridge 5 is mounted in a reverse manner) position detached from the lower end 6b or upper end 6a of the outer tube 6 or from a seal component 11 mounted therein, so that the fluid communication among the inner chamber IC and the outer chamber OC (or rather the lower part OC2 thereof) is open and thus the fluid or oil can flow from the inner chamber IC to the outer chamber OC (or rather to the lower part OC2 thereof) or vice versa through the channels or openings or passages among the lower end 6b or upper end 6a of the outer tube 6 or a respective seal component 11 and the valve unit 9 and/or throughout the valve unit itself, for example through holes or the like of the shutter component 14.

In this respect, the valve body 13 is connected or fixed to the lower end 7a or upper end of the inner tube 7, whereas the shutter component 14 is slidingly connected to the valve body 13, whereas the valve unit 9 further includes elastic loading means 15, for example a wave spring, arranged to yieldingly oppose the displacement of the shutter component 14 with respect to the valve body 13, the shutter component 14 being actuated in contrast with the elastic loading means 15.

Preferably, the shutter component 14 comprises or consists of a poppet valve. More preferably, the shutter component 14 is preferably shaped as a solid of rotation around an axis of symmetry, which axis corresponds to the axis x-x.

More particularly, with reference to the not limiting embodiment shown in the figures, the poppet valve 14 includes a stem 14a, for example solid, i.e. not hollow and whose cross-section could be circular, polygonal, etc., which stem 14a is arranged for being pressed by the actuator mechanism 12. The stem 14a can be for example mounted in a seal component or head 11 sealingly mounted in the lower end 6b or upper end 6a of the outer tube 6 in such a manner that the stem tip protrudes beyond or outside with respect to such seal component 11 and is engageable or actuatable by the actuator mechanism 12.

The shutter component 14 can further include an interception portion 14b, suitable for opening/closing the fluid communication among the chambers IC, OC.

In this respect, the interception portion 14b can be plate-shaped or disc-shaped or shaped in a different manner, and it is provided or connected at the end of the stem 14a.

The interception portion 14b can delimit one or more through holes H1, for example one integer number among two and eight or more. Such through holes H1, if provided, could extend in a direction parallel to the axis x-x of the tubes 6, 7 or inclined with respect to such an axis.

If desired, the poppet valve 14 can further include a fitting tubular portion 14c extending from the interception portion 14b, defining a channel path PC in fluid communication with the holes H1, if provided, and arranged to be slidingly mounted in the lower end 7a or upper end of the inner tube 7. The channel path PC actually constitutes a lower portion of the inner chamber IC.

The poppet valve 14 can also include a shoulder portion 14d, for example annular-shaped, extending outwards from the fitting tubular portion 14c and arranged to define, together with the interception portion 14b, a seat for a gasket or the like 14e.

Preferably, the poppet valve 14 is enbloc or made in a single piece.

So far as now the valve body 13 is concerned, the same can for example include a sleeve tubular component, with a first or upper end 13a mounted on (for example owing to a press fit connection) and enclosing the lower end 7a or upper end of the inner tube 7. Such first end 13a can be L-shaped in cross-section, so as to result folded inwardly.

The sleeve tubular component 13 protrudes downwardly or upwardly from the first end 13a until the other or second end 13b and slidingly receives the shutter component 14, for example the interception portion 14b and the fitting tubular portion 14c.

If desired, the valve body 13 can also include an intermediate tubular wall 13c protruding inwardly from the main structure thereof and defining a shoulder 13d facing upwards or facing towards the seat clamps or connector 3.

The valve body 13 can be mounted on the respective lower end 7a or upper end (if the cartridge 5 is mounted in a reversed manner) of the inner tube 7 so that the latter is seated flush with the inner surface of the intermediate tubular wall 13c and abutting or at the shoulder 13d.

The second end 13b of the valve body 13 is preferably tubular-shaped, and, if desired, can delimit one or more notches 13e open downwardly.

A gasket or the like 13f can be arranged among the first end 13a and the intermediate tubular wall 13c.

Referring now to the not limiting embodiment shown in the figure, the elastic loading means 15, for example a spring, such as a wave spring or another spring, are arranged and act among the intermediate tubular wall 13c and the interception portion 14b or, if provided, the shoulder portion 14d.

The elastic loading means 15 could also be tunable.

So far as now the seal component 11 is concerned, the same can be suitably shaped, for example with a main portion 11a and optionally a tang portion 11b, for example lower.

The seal component 11 is preferably shaped as a solid of rotation around an axis of symmetry corresponding to the axis x-x.

The seal component 11 includes for example a tubular shape with a through opening TO, if desired along the axis of longitudinal symmetry, extending in the main portion 11, and, if provided, in the tang portion 11b.

More particularly, the inner wall or surface of the seal component 11 or rather of the main portion 11a at the through opening TO has a first portion 11d, for example tubular with a first diameter or cross section, then a second portion 11e, for example tubular with a second diameter or cross section greater than the first diameter or cross section and then a third portion 11f, with a third diameter or cross section lower than the first diameter or cross section.

With reference to such an aspect, the shutter component 14 or rather the interception portion 14b is arranged to slide flush with respect to the first portion 11d of the inner wall 11c of the seal component 11, whereas the stem 14a is designed or arranged to slidingly engage the third portion 11f protruding therefrom in addition to the tang portion 11b or the respective opening.

Moreover, inner 11g or outer 11b groove, if desired annular, can be provided in the seal component 11 designed to house respective gasket or the like.

The stem 14a of the shutter component can protrude downwardly or upwardly with respect to the seal component 11 and, optionally, to a closing component 26 of the lower, in use, end of the lower tube 4 or upper, in use, end of the upper tube (if the cartridge 5 is mounted in a reversed manner), so that a tip thereof is engageable by the actuator mechanism 12.

Furthermore, the seatpost 1 can also include a floating piston 16 mounted in the outer chamber OC and arranged to sealingly separate the first or upper part OC1 of the same filled in with gas from the respective second or lower part OC2 filled in fluid or hydraulic oil. As it will be understood, the floating piston 16 is displaced owing to the fluid communication among inner chamber IC and outer chamber OC, and thus as soon as (when the valve unit 9 is open and as a function of the load or force applied on the seat clamps or connector 3) the fluid or oil passes from the inner chamber IC to the outer chamber OC or to the second or lower part OC2 thereof, the floating piston 16 moves upwards or downwards (if the cartridge 5 is mounted in a reversed manner), whereas when the fluid or oil passes from the outer chamber OC or rather from the lower part OC2 thereof to the inner chamber IC, the floating piston 16 moves downwards or upwards (if the cartridge 5 is mounted in a reversed manner).

The floating piston 16 is preferably annular or tubular shaped and it has a cross-section substantially corresponding or slightly less than the cross-section of the outer chamber among the outer 6 and inner 7 tube.

The floating piston 16 is preferably shaped as a solid of rotation around an axis of symmetry, which axis corresponds to the axis x-x.

The floating piston 16 can also delimit inner 16a and outer 16b annular grooves for housing respective gasket or the like.

As a matter of fact, with the above-mentioned structure, as soon as the actuator mechanism 12 pushes or acts on the shutter 14, for example on the stem 14a thereof, the shutter 14 or poppet valve is displaced along axis x-x with respect the valve body 13, so that the valve unit 9 is open, and thus the fluid or oil can flow from the inner chamber IC to the outer chamber OC or vice versa as a function of the force or load applied to the seat clamps or connector 3.

When considering the not limitative structure disclosed in the figures, the fluid or oil can pass among the chambers IC, OC or rather IC, OC2 through the notches 13e, under the poppet valve 9, through the through holes H1 and then into the channel path PC of the fitting tubular portion 14c.

More particularly, gas, preferably pressurized gas is inside the first or upper part OC1 of the outer chamber OC, and the same exerts a force against floating piston 16. In this case, the second or lower part OC2 of the outer chamber OC and the inner chamber IC are full of fluid or oil, whereas the spring 15 forces the poppet valve 14 to move downwards or upwards (if the cartridge 5 is mounted in a reversed manner) against seal component 11, which prevents fluid or oil from traveling between chambers OC and IC, which fixes the seatpost position regardless of the load applied to plunger rod 8.

When poppet valve 14 is pushed upwards, the same or rather the respective interception portion 14b is no longer sealed against seal component 11, which allows fluid or oil to flow between chambers OC and IC. When the valve unit 9 is open, if seat clamps or connector 3 or the overlying seat or saddle SA is pushed downwards to reduce seatpost height, then fluid or oil will flow from chamber IC into chamber OC or OC2 and floating piston 16 will move upwards or downwards, which further compresses gas within chamber OC1. When the valve unit 9 is open, if the force downwards on seat clamps or connector 13 or seatpost head is removed, gas within chamber OC1 will force floating piston 16 downwards or upwards, which causes fluid or oil to flow from chamber OC2 into chamber IC, thereby raising the seatpost.

Owing to the present invention, the valve unit 9 or rather the shutter component 14 is never pressure loaded, and at the same time a high flow of fluid or oil is obtained as soon as the actuator mechanism pushes or acts on the shutter component 14.

When an adjustable seatpost is compressed, the travel or plunger rod 8 is pressed into the cartridge 5, so that the latter displaces fluid or oil and increases the gas spring force. By using a solid plunger rod system, the displacement volume can be reduced further aiding in reducing overall axial length. In prior art embodiments, the hollow travel rod is expensive and may be prone to failure. The solid travel rod design reduces cost and adds strength to the system by requiring less machining or extruding as well as accommodating smaller diameters for a given axial compressive strength.

Moreover, all current adjustable travel seatposts on the market today use a valve that is attached to the travel rod. Separating the valve from the travel rod facilitates the use of a smaller volume travel rod as it does not have to accommodate the extra space for the valve. It also allows for a lower cost part as the valve and the travel rod are not required to be attached to each other. Lighter weight can also be achieved as the valve can then be located closer to the actuation point.

Advantageously or in accordance with a second preferred and not limitative aspect of the present invention, the seatpost 1 includes a travel limiting device or unit for adjusting 17, 18 the full length thereof and thus the maximum height of the seat clamps or connector 3 and, in turn, of a seat or saddle SA mounted thereon.

Such unit 17, 18, if provided, comprises at least two components 17, 18 for adjusting, i.e. a first component 17 with a curved outline extending around the axis x-x and defining a plurality of recesses 19 and/or protruding portions 20 offset one with respect to the other around the axis x-x and with an extension or position different with one another in a direction parallel to the axis x-x, as well as a second component 18.

The second component 18 includes at least one protrusion 21 and/or hollow zone 22 arranged to selective engage or abut one of the recesses 19 or protruding portion 20.

The components 17, 18 are controllably displaceable, preferably after the seatpost 1 has been at least partly disassembled, one with respect to the other, so that the extension or length of the unit for adjusting 17, 18 is varied or variable as a function of or depends upon the recess 19 and/or protruding portion 20 of the first component 17 engaged by the protrusion 21 and/or hollow zone 22. In this respect, the adjustment of the mutual position of the components 17, 18, even if carried out when the same are disassembled from the other components of the seatpost 1, results, as soon as the seatpost 1 is assembled again, in a displacement of the components 17, 18 one with respect to the other around the axis x-x.

Moreover, the unit 17, 18 is integral or connected or clamped or fitted to the lower tube 4 or to the upper tube 2, whereas the other among upper tube 2 or lower tube 4 includes a portion designed to abut or engage against the unit 17, 18 as soon as the plunger rod 8 of the cartridge 5 with the upper tube 2 and, in turn, the seatpost 1 is extended to a full length, and thus for example the more the unit 17, 18 is long the less is the full length of the seatpost 1 and vice versa.

With reference to not limiting embodiment shown in the figures, the upper tube 2 includes an enlarged lower end 2a or a ledge or bulging component 24, for example annular is mounted or connected or fixed to the upper tube 2, for example at or close to the lower end 2a, clearly in a respective location 2b, for example recessed and optionally annular, whereas the unit 17, 18 is integral or connected or clamped or fitted to the lower tube 4 and protrudes inwardly from the same, so that as soon as the upper tube 2 is brought to a full length, owing to the action of the cartridge 5, i.e. the extension of the plunger rod 8, the enlarged lower end 2a or the ledge or bulging component 24 will abut or engage the unit 17, 18, which thus will act as end of the stroke for the sliding displacement of the upper tube 2.

Advantageously, the first component 17 includes at least one first tubular or annular base portion 17a as well as a first extending portion 17b, whereas the plurality of recesses 19 and/or protruding portions 20 are each defined at a respective part angularly offset from the other or others of the extending portion 17b.

When considering the not limitative example shown in the figures, the first component 17 includes, starting from a given position and following a circular path around the extension of the first component 17 about the axis x-x or moving substantially circumferentially or in any case around the respective axis x-x, a first step defining a first protruding portion 20a with free end at a given first distance from the tubular or annular base portion 17a, then a first recess 19a with a given depth so as a to have an upper end, i.e. the end closer to the base portion 17a, at a given second distance from the latter lower than first distance.

Subsequently, the first component 17 has a second step defining a second protruding portion 20b with free end at a given third distance from the tubular or annular base portion 17a greater (3/2, double, triple, etc.) than the first distance, then a second recess 19b with a given depth so as a to have an upper end, i.e. the end closer to the base portion 17a, at a given fourth distance from the latter greater than the second distance and, optionally than the first distance.

Then, the first component 17 has a third step defining a third protruding portion 20c with free end at a given fifth distance from the tubular or annular base portion 17a greater (3/2, double, triple or greater/lower) than the third distance, then a third recess 19c with a given depth so as a to have an upper end, i.e. the end closer to the base portion 17a, at a given sixth distance from the latter greater than the fourth distance and, optionally than the third distance.

Such alternation of steps and recesses with distance from the base portion 17a increasing can be repeated for a number of times, so as to have five, six, seven or one integer number from eight to twenty and more.

In this respect, preferably, the first component 17, starting from a given position and following a circular path around its extension about the axis x-x, following one direction of rotation, clockwise or counterclockwise, has an alternation of steps and recesses with distance from the base portion 17a increasing for a half of its extension until reaching a step with a greatest distance from the base portion 17a.

If one continues following the circular path of the first component 17 for the second half thereof, the first component 17 includes another first step, first recess, second step, second recess and so on.

Thus, the first component 17 can include a pair of semi-tubular portions or parts one after the other and with substantially the same shape to one another.

Still more advantageously, the second component 18 has a curved outline extending around the axis x-x and comprises a plurality of protrusions 21 and/or hollow zones 22 offset one with respect to the other around the axis x-x and with an extension or position different with one another in a direction parallel to the axis x-x.

The second component 18 can include at least one first tubular or annular base portion 18a as well as a second extending portion 18b, whereas the plurality of protrusions 21 and/or hollow zones 22 are each defined at a respective part angularly offset from the other or others of the extending portion 18b.

Preferably, the second component 18 can have a shape substantially corresponding to that of the first component 17, and thus, starting from a given position and following a circular path around the extension of the second component 18 about the axis x-x or moving substantially circumferentially or in any case around the respective axis x-x, it can include a first step defining a first protrusion 21a with free end at a given first distance from the tubular or annular base portion 18a, then a first hollow zone 22a with a given depth so as a to have an lower end, i.e. the end closer to the base portion 18a, at a given second distance from the latter lower than first distance.

Subsequently, the second component 18 has a second step defining a second protrusion 21b with free end at a given third distance from the tubular or annular base portion 18a greater (3/2, double, triple, etc.) than the first distance, then a second hollow zone 22b with a given depth so as a to have an lower end, i.e. the end closer to the base portion 18a, at a given fourth distance from the latter greater than the second distance and, optionally than the first distance and so on as described for the first component.

Even in this case, such alternation of steps and hollow zones with distance from the base portion 18a increasing can be repeated for a number of times, so as to have five, six, seven and one integer number from eight to twenty and more.

Moreover, the second component 18 can include a pair of semi-tubular portions or parts one after the other and with substantially the same shape, i.e. with alternation of steps and hollow zones with distance from the base portion 18a increasing for a half of its extension until reaching a step with a greatest distance from the base portion 18a, and then another first step, first hollow zone, second step, second hollow zone and so on.

Substantially, the components 17, 18 can include, in accordance with the not limiting embodiment shown in the figure, two circular bushings that are stepped axially and have a mirrored stepped feature to each other, so that the two stepped bushings can be separated and re-clocked to each other to achieve a different axial length, thereby changing the maximum extension of the adjustable seatpost and result in a different overall length when fully extended.

Advantageously, each protrusion/s 21 is shaped so that is be snap engaged/engageable or fitted/fittable to a respective recess 19 and each hollow zone 22 is shaped so that it can be snap engaged/engageable or fitted/fittable to a respective protruding portion 20. In this respect, the protrusion/s 21 and/or hollow zone/s 22 can be dovetail-shaped and the same applies to the recesses 19 or protruding portions 20, so that the engagement among each protrusion 21 and/or hollow zone 22 with a respective recess 19 or protruding portion 20 determines a substantially dovetail joint.

The unit for adjusting 17, 18 can be mounted among the upper 2 and lower 4 tube.

Moreover, the seatpost 1 can also include a retaining element 23, such as ring nut or the like component, arranged to maintain the position of the unit for adjusting 17, 18 at least along a direction parallel to the axis x-x. The retaining element 23 could include, for example a main tubular wall 23a and, if desired a second wall 23b extending inwardly from the main tubular wall 23a, for example transversally or orthogonally with respect to the main tubular wall 23a. The second wall 23b could also be suitably shaped so as a delimit a terminal step 23c.

In this respect, according to the not limiting embodiment shown in the figures, the retaining element 23 is fitted or mounted or connected on the upper end 4a of the lower tube 4, and the lower tube 4 includes or delimits or is provided with an inner shoulder 4b, which is tubular or with one or more sections, such shoulder 4b being arranged at a given distance from the upper end 4a, so that a specific area is delimited among the upper end 4a and the inner shoulder 4b.

The unit 17, 18 can be mounted inside the lower tube 4, with the retaining element 23 removed, until it abuts or rests on the inner shoulder 4b and then with the aim of rendering the unit 17, 18 fixed or integral or connected to the lower tube 4, the retaining element 23 is mounted and connected to the upper end 4a, for example following a screwing engagement among an inner thread of the retaining element 23 or of the respective main tubular wall 23a with an outer thread at the upper end 4a, so that the unit 17, 18 is contained or fixed or fastened among the shoulder 4b and the retaining element 23 or rather the second wall 23b or the terminal step 23c thereof.

To this regard, the lower tube 4 could also delimit a central through opening, which has a lower, in use, part with a given first diameter or cross section and an upper, in use, part with a given second diameter or cross section greater than the first diameter or cross section, so that the inner shoulder 4b is defined among such parts.

As it will be understood, the components 17, 18 can be separated and re-clocked or connected, for example owing to a dovetail engagement, to each other to achieve a different axial length, as a function of the protrusion/s 21 or hollow zone/s 22 and recess/es 19 or protruding portion/s 20 selected for the engagement or the connection.

This change in axial length of the components 17, 18 or bushings will change the maximum extension of the adjustable seatpost and result in a different overall length when fully extended.

This then allows the end user to set their proper seat height by using the travel limiting feature, which then provides the user with the maximum amount of seatpost travel for a given seat height position.

By using a two-piece, mating, travel limit adjustment spacer system, several benefits over current embodiments are achieved.

In this respect:
no parts need to be added or removed, thus aiding in keeping the system free of debris and there are no parts to lose,
there are no orientation changes required which aids in the simplicity of adjustment, and
the upper bearing system surface is maximized.

If desired, the seat post 1 can further include one or more (two according to the not-limiting embodiment shown in the figures) slats or keys 25 fixed or connected or fitted to one among upper 2 and lower 4 and designed to slidingly engage slots (not shown), preferably extending parallel to the axis x-x, formed or delimited in the other among lower 4 and upper 2 tube. Of course, the slats or keys 25 are aimed at preventing a mutual rotation of the upper tube 2 with respect to the lower tube 4, so that such tubes 2, 4, during the standard operation of the seatpost 1 and as a function of the action of the cartridge 5, can just slide one with respect to the other.

In this respect, according to the not-limiting embodiment shown in the figures, one, two or more keys 25 are forced or fitted in slots or housing areas formed or delimited in the upper tube 2 and designed to slidingly engage slots formed or delimited in the upper 2 tube.

In this case, the keys 25 could slide at a distance from the axis x-x of the seatpost 1 lower than the distance from such axis of the components 17, 18, so that the keys 25 do not slam against the components 17, 18, but slide flush to the same at a position closer to the axis with respect to such components 17, 17.

If desired, the seatpost 1 is also provided with an annular seal element 28 mounted or inserted on the upper tube 2 above the retaining component 23, i.e. between the retaining component 23 and the seat clamps or connector 3. The annular seal element 28 could be for example received in a zone defined among the retaining element 23 or the main 23a and second 23b wall thereof, on the one side, and the sliding upper tube 2, on the other.

The seatpost 1 can also include a closing component 26 of the lower, in use, end 4c of the lower tube 4.

In this respect, the closing component 26 can be provided with an outer thread 26a to be screw engaged with an inner thread of the lower end 4c of the lower tube. Of course, another suitable connection among the closing component 26 and the lower tube 4 can be arranged.

The closing component 26 is preferably ring-shaped.

In this case, the lower tang portion 11b, if provided, can be connected to the closing component 26, for example screwed in a threaded through opening 26b, for example central of the latter. In this respect, the lower tang portion 11b has an outer thread portion.

Advantageously or in accordance with a third preferred and not limitative aspect of the present invention, the seatpost 1 comprises the closing component 26, whereas the actuator mechanism 12 includes a lever component 27 and a cable 30 received in a respective housing 31 or sheath, with a lower end 30a of the cable 30 being fixed or attached in the closing component 26 of the lower end 4c of the lower tube 4, whereas the housing or sheath 31 acts against the lever component 27, so that as soon as the upper end (not shown) of the cable 30 is pulled, owing to the action of a user by a remote lever RL or button control on the other or upper end of the cable 30, the housing 31 determines the displacement of the lever component 27 and the engagement or actuation of the valve unit 9.

In this case, the closing component 26 preferably delimits a shaped opening SO, preferably a shaped through opening SO for the lower end 30a of the cable 30 or for a cap component 32 mounted thereon.

In this respect, a cap component 32 is preferably arranged having a volume or encumbrance higher (two, three or more times) than the cable 30.

So far as the shaped opening SO is concerned, the same can include for example a main section SO1, for example circular in cross section and greater than the cross-section or encumbrance of the cap component 32, as well as an auxiliary section SO2 with a cross section lower than the cross-section or encumbrance of the cap component 32, but greater, although slightly, than the cross-section or encumbrance of the cable 30.

Thus, if one should connect the cable 30 to the closing component 26, it would suffice to insert the cap component 32 with the cable 30 in the main section SO1 and then to slide or displace the cable 30 so that the same slide or move into the auxiliary section SO2, so that the cap component 32, greater than the auxiliary section SO2, would prevent the cable 30 from being disconnected from the closing component 26.

Referring now to the lever component 27, with reference to the not limiting embodiment shown in the figures, it is hinged or pivoted to one or more bracket component/s 33 fixed or connected in any suitable manner to the lower tube 4 or, if provided to the closing component 26.

Moreover, the lever component 27 could delimit a connection through hole or opening CHO with a cross section varying or rather lowering (gradually or not) in a direction towards the lower tube 4 or the closing component 26. More particularly, the connection through hole or opening CHO has a first segment CHO1, for example circular or square or rectangular in cross-section, with a cross-section or encumbrance greater than a second segment CHO2, for example slat-shaped, so that the cable 30 pass through the whole hole or opening, but the housing or sheath 31 passes through the first segment HO1, but is larger or greater than the second segment CHO2, and thus it abuts or hints the lever component 27 at respective inner wall or parts 27a deliming the second segment H02.

Furthermore, the lever component 27 can further delimit a through slit SL at an end thereof and in communication with the connection through hole or opening CHO, so that it is possible to insert the cable 30 into the connection through hole or opening CHO starting from the through slit SL. In this respect, as it will be understood, a lower, in use, part of the cable 30 is inserted into the slit SL with the cap component 32 placed opposite to the lower end of the housing or sheath 31 with respect to the lever component 27, and then the cable 30 or the housing or sheath 31 are adapted so as to bring the latter into the first segment HO1 of the connection through hole or opening CHO and in engagement with the inner surface/s of the lever component 27 defining such opening CHO.

Owing to such a structure, as soon as the lower end 30a of the cable 30, mounted in the shaped opening SO, is pulled, the housing 31 pushes or acts at the wall or parts 27a of the lever component 27 and thus determines the displacement of the latter 27 and the engagement or actuation of the valve unit 9 or rather of the poppet valve 14, for example of a respective stem 14a or stem tip, thereby causing the opening of the valve unit 9.

Subject-matter of the present invention is also a bicycle B having a frame FR, a seat or saddle SA and an adjustable height seatpost 1 as above-described in accordance with the first and/or second and/or third aspect. In such case the frame includes at least one tubular component TC with the lower tube of the adjustable height seatpost 1 mounted therein, whereas the seat or saddle SA is connected to the seat clamps or connector 3.

Of course, the bicycle further includes a handlebar HA as well as a remote lever RL or button control mounted thereon or on another component of the frame, which lever or button control is suitable for controlling the adjustable height seatpost 1 or rather the respective actuator mechanism 12.

So far as the other or second or upper end of the cable 30, the same is connected to the remote lever RL or button control, whereas the other end of the housing or sheath 31 is mounted or connected to the handlebar HA or to another component of the frame FR of the bicycle B.

As it will be appreciated, the most of current cable actuated adjustable height seatposts use a fixed housing end with a translating cable running through them to a translating or rotating cable end. This generally requires additional overall axial length to be added to the post in order to accommodate this method of actuation as in most embodiments the actuation device is added outside of the seatpost body. Further extending the axial length of the post, many current embodiments require both housing and cable to be fixed outside of the post body. In another prior art solution, an access hole in the body is required in order to secure the housing and cable inside the seatpost body. This extends the post body well below the housing and cable anchor points which again adds axial length to the post.

By fixing the cable end and allowing the housing to translate as in accordance with the third preferred and not limitative aspect of the present invention, the cable end 30a can then be attached inside the body (closing component 26) of the adjustable height seatpost 1 reducing the overall length by at least the axial length of the cable end 30a. In attaching the cable end 30a into the body (closing component 26) of the seatpost at the base of the latter, no access window is required, and no additional length is required to accommodate the cable end mounting point. This embodiment also allows for air to pass in and out of the seatpost with low force which aids in reducing the forces required to translate the seatpost.

The components of the seatpost 1 can be made of any suitable material, for example of metal, such as steel or aluminum or a polymer, such as a PTFE or POM or other materials.

Of course, even if not described or shown in detail, other suitable means for sealing the chambers or zones of the seatpost can be provided.

The present invention has been described according to a preferred embodiment, but equivalent variants can be devised without departing from the scope offered by the following claims.

1. An adjustable height or dropper seatpost for a bicycle including:
an upper, in use, tube,
seat clamps or connector for connecting the seatpost to a bicycle seat, which seat clamps or connector are/is supported by and integral in vertical translation with said upper tube,
a lower, in use, tube, with the upper tube being slidingly mounted in the lower tube or vice versa along an axis,
a cartridge mounted inside the lower and upper tubes, said cartridge having an outer tube, an inner tube coaxially mounted inside the outer tube, a plunger rod being slidingly mounted inside the inner tube with an upper, in use, end of the plunger rod or an upper, in use, end of the outer tube connected to the seat clamps or connector and integral in vertical translation therewith, said cartridge defining an outer chamber between the outer tube and the inner tube filled in at a respective first part with gas, and at a respective second part filled in with fluid or oil and an inner chamber adjustably defined at the second part of the inner tube as a function of the position of the plunger rod and filled in with fluid or oil as the second part of the outer chamber, said cartridge further including a valve unit arranged to close/open the fluid communication among the second part of the outer chamber and said inner chamber,
an actuator mechanism arranged to open/close said valve unit, so that when the actuator mechanism is in a closed position, the fluid communication among said inner chamber and outer chamber is prevented, the seatpost is locked and the fluid or oil contained in the inner chamber supports the plunger rod, and, in turn, a rider's weight, whereas when the actuator mechanism is in an open position, it opens the fluid communication among said inner chamber and outer chamber, thereby fluid or oil can flow among such chambers, so that, as a function of the force or load applied to the seat clamps or connector, it is possible to adjust the position of the plunger rod inside the inner tube and, in turn, the height of the seatpost,
wherein said valve unit comprises a valve body or housing mounted at the lower or upper end of said inner tube, as well as a shutter component of said valve unit slidingly mounted in the lower or upper end of the outer tube or in a seal component mounted therein and engageable by said actuator mechanism for opening/closing said valve unit.

2. The seatpost as claimed in claim 1, wherein the shutter component is mounted movable, by means of the actuator mechanism among a raised position and a lowered position with respect to the inner tube and with respect to the lower or upper end of the outer tube, so that when the actuator mechanism is in a closed position, the shutter component is lowered or raised and sealingly abutted against the lower or upper end of the outer tube or against a seal component mounted therein, so that the fluid communication among the inner chamber and outer chamber is prevented, whereas when the actuator mechanism is in an open position, it pushes or acts on the shutter component and brings the same to a raised or lowered position detached from the lower or upper end of the outer tube or from a seal component mounted therein, so that the fluid communication among the inner chamber and the outer chamber is open and thus the fluid or oil can flow from the inner chamber to the outer chamber or vice versa through the channels or openings or passages among the lower or upper end of the outer tube or a respective seal component and the valve unit and/or throughout the valve unit itself.

3. The seatpost as claimed in claim 1, wherein the valve body is connected or fixed to the lower or upper end of the inner tube, whereas the shutter component is slidingly connected to the valve body, whereas the valve unit further includes elastic loading means arranged to yieldingly oppose the displacement of the shutter component with respect to the valve body, the shutter component being actuated in contrast with the elastic loading means.

4. The seatpost as claimed in claim 1, wherein said shutter component comprises or consists of a poppet valve.

5. The seatpost as claimed in claim 4, wherein said poppet valve includes a stem arranged for being pressed by the actuator mechanism, said stem being mounted in a seal component sealingly mounted in the lower or upper end of the outer tube in such a manner that the stem tip protrudes beyond or outside with respect to such seal component and is engageable or actuatable by the actuator mechanism,
the shutter component further including an interception portion, suitable for opening/closing the fluid communication among the inner and outer chambers, the interception portion being plate-shaped or disc-shaped.

6. The seatpost as claimed in claim 5, wherein said interception portion delimit one or more through holes, whereas the poppet valve further includes a fitting tubular portion extending from the interception portion and defining a channel path in fluid communication with such through holes, such fitting tubular portion being slidingly mounted in the lower or upper end of the inner tube.

7. The seatpost as claimed in claim 1, wherein the valve body includes a sleeve tubular component, with a first end of the valve body mounted on and enclosing the lower or upper end of the inner tube, the sleeve tubular component protruding downwardly or upwardly from the first end of the valve body until the other or second end thereof slidingly receiving the shutter component.

8. The seatpost as claimed in claim 5, comprising a seal component mounted in the lower or upper end of the outer tube, and wherein such seal component includes a main portion and a tang portion and has a tubular shape with a through opening extending along the respective axis of longitudinal symmetry, both in the main portion, and in the tang portion,
wherein the inner wall or surface of the main portion at the through opening has a first portion with a first diameter or cross section, then a second portion with a second diameter or cross section greater than the first diameter or cross section and subsequently a third portion with a third diameter or cross section lower than the first diameter or cross section,
wherein the interception portion of the shutter component is arranged to slide flush with respect to the first portion of the inner wall of the seal component, whereas the stem is designed or arranged to slidingly engage the third portion protruding therefrom in addition to the tang portion or the respective opening.

9. The seatpost as claimed in claim 1, wherein said plunger rod is solid, i.e. not hollow.

10. The seatpost as claimed in claim 1, comprising a floating piston mounted in said outer chamber and arranged to sealingly separate the first part filled in with gas and the second part filled in with fluid or oil of said outer chamber.

11. A bicycle having a frame, a seat or saddle and an adjustable height seatpost as claimed in claim 1, said frame including at least one tubular component with the lower tube of the adjustable height seatpost mounted therein, said seat or saddle being instead connected to said seat clamps or connector, said bicycle further including a handlebar as well as a remote lever or button control mounted thereon or on another component of the frame and suitable for controlling said adjustable height seatpost or rather said actuator mechanism.

12. An adjustable height or dropper seatpost for a bicycle including:
an upper, in use, tube,
seat clamps or connector for connecting the seatpost to a bicycle seat, which seat clamps or connector are/is supported by and integral in vertical translation with said upper tube,
a lower, in use, tube, with the upper tube being slidingly mounted in the lower tube or vice versa along an axis,
a cartridge mounted inside the lower and upper tubes, said cartridge having an outer tube, an inner tube coaxially mounted inside the outer tube, a plunger rod being slidingly mounted inside the inner tube with an upper, in use, end of the plunger rod or an upper, in use, end of the outer tube connected to the seat clamps or connector and integral in vertical translation therewith, said cartridge defining an outer chamber between the outer tube and the inner tube filled in at a respective first part with gas, and at a respective second part filled in with fluid or oil and an inner chamber adjustably defined at the second part of the inner tube as a function of the position of the plunger rod and filled in with fluid or oil as the second part of the outer chamber, said cartridge further including a valve unit arranged to close/open the fluid communication among the second part of the outer chamber and said inner chamber,
an actuator mechanism arranged to open/close said valve unit, so that when the actuator mechanism is in a closed position, the fluid communication among said inner chamber and outer chamber is prevented, the seatpost is locked and the fluid or oil contained in the inner chamber supports the plunger rod, and, in turn, a rider's weight, whereas when the actuator mechanism is in an open position, it opens the fluid communication among said inner chamber and outer chamber, thereby fluid or oil can flow among such chambers, so that, as a function of the force or load applied to the seat clamps or connector, it is possible to adjust the position of the plunger rod inside the inner tube and, in turn, the height of the seatpost,
wherein the seatpost includes a unit for adjusting the full length thereof and thus the maximum height of said seat clamps or connector, and, in turn, of a seat or saddle mounted thereon,
said unit for adjusting comprising at least two components for adjusting, i.e. a first component with a curved outline extending around the axis and defining a plurality of recesses and/or protruding portions offset one with respect to the other around said axis and with an extension or position different with one another in a direction parallel to said axis, said unit for adjusting further comprising a second component including at least one protrusion and/or hollow zone arranged to selective engage or abut one of said recesses or protruding portions, said at least two components being controllably displaceable one with respect to the other so that the extension or length of said unit for adjusting is varied or variable as a function of or depends upon the recess or protruding portion of said first component engaged by said protrusion or hollow zone,
said unit for adjusting being integral or connected or clamped or fitted to said upper tube or to said lower tube, whereas the other among lower tube and upper tube includes a portion designed to abut or engage against said unit as soon as the plunger rod of the cartridge with the upper tube and, in turn, the seatpost is extended to a full length.

13. The seatpost as claimed in claim 12, wherein said first component includes at least one first tubular or annular base portion as well as a first extending portion, whereas the plurality of recesses and/or protruding portions are each defined at a respective part angularly offset from the other or others of the extending portion.

14. The seatpost as claimed in claim 12, wherein said second component has a curved outline around the axis and comprises a plurality of protrusions or hollow zones offset one with respect to the other around said axis and with an extension or position different with respect to other in a direction parallel to said axis.

15. The seatpost as claimed in claim 14, wherein said second component includes at least one second tubular or annular base portion as well as a second extending portion, whereas the plurality of protrusions and/or hollow zones are each defined at a respective part angularly offset from the other or others of the extending portion.

16. The seatpost as claimed in claim 12, whereas said at least two components for adjusting include two circular bushings that are stepped axially and have a mirrored stepped feature to each other, so that the two stepped bushings are separated and re-clocked to each other to achieve a different axial length, thereby changing the maximum extension of the adjustable seatpost and result in a different overall length when fully extended.

17. The seatpost as claimed in claim 12, wherein the seatpost includes a retaining element arranged to maintain the position of the unit for adjusting at least along a direction parallel to the axis, said retaining element including a main tubular wall and a second wall extending inwardly from the main tubular wall,
said retaining element being fitted or mounted or connected on the upper end of the lower tube, and the lower tube includes or delimits or is provided with an inner shoulder arranged at a given distance from such upper end, so that a specific area is delimited among the upper end and the inner shoulder,
the unit being mounted inside the lower tube so as to abut or rest on said inner shoulder, whereas the retaining element is mounted and connected to the upper end, so that the unit for adjusting is contained or fixed or fastened among the inner shoulder and the retaining element.

18. A bicycle having a frame, a seat or saddle and an adjustable height seatpost as claimed in claim 12, said frame including at least one tubular component with the lower tube of the adjustable height seatpost mounted therein, said seat or saddle being instead connected to said seat clamps or connector, said bicycle further including a handlebar as well as a remote lever or button control mounted thereon or on another component of the frame and suitable for controlling said adjustable height seatpost or rather said actuator mechanism.

19. An adjustable height or dropper seatpost for a bicycle including:
an upper, in use, tube,
seat clamps or connector for connecting the seatpost to a bicycle seat, which seat clamps or connector are/is supported by and integral in vertical translation with said upper tube,
a lower, in use, tube, with the upper tube being slidingly mounted in the lower tube or vice versa along an axis,
a cartridge mounted inside the lower and upper tubes, said cartridge having an outer tube, an inner tube coaxially mounted inside the outer tube, a plunger rod being slidingly mounted inside the inner tube with an upper, in use, end of the plunger rod or an upper, in use, end of the outer tube connected to the seat clamps or connector and integral in vertical translation therewith, said cartridge defining an outer chamber between the outer tube and the inner tube filled in at a respective first part with gas, and at a respective second part filled in with fluid or oil and an inner chamber adjustably defined at the second part of the inner tube as a function of the position of the plunger rod and filled in with fluid or oil as the second part of the outer chamber, said cartridge further including a valve unit arranged to close/open the fluid communication among the second part of the outer chamber and said inner chamber,
an actuator mechanism mounted at the lower, in use, end of the outer tube and arranged to open/close said valve unit, so that when the actuator mechanism is in a closed position, the fluid communication among said inner chamber and outer chamber is prevented, the seatpost is locked and the fluid or oil contained in the inner chamber supports the plunger rod, and, in turn, a rider's weight, whereas when the actuator mechanism is in an open position, it opens the fluid communication among said inner chamber and outer chamber, thereby fluid or oil can flow among such chambers, so that, as a function of the force or load applied to the seat clamps or connector, it is possible to adjust the position of the plunger rod inside the inner tube and, in turn, the height of the seatpost,
the seatpost comprising a closing component of the lower, in use, end of the lower tube, whereas said actuator mechanism includes a lever component and a cable received in a respective housing or sheath, a lower end of the cable being fixed or attached in said closing component of the lower, in use, end of the lower tube, whereas said housing or sheath acts against said lever component, so that as soon as the lower end of the cable is pulled, the housing determines the displacement of the lever component and the engagement or actuation of the valve unit.

20. The seatpost as claimed in claim 19, comprising a cap component mounted on the lower end of the cable and with a volume or encumbrance higher than the cable, wherein said closing component delimits a shaped through opening for the lower end of the cable and for a cap component mounted thereon.

21. The seatpost as claimed in claim 19, wherein the shaped opening includes a main section with cross section or encumbrance greater than the cross-section or encumbrance of the cap component, as well as an auxiliary section with a cross section lower than the cross-section or encumbrance of the cap component, but greater than the cross-section or encumbrance of the cable.

22. The seatpost as claimed in claim 19, wherein the lever component is hinged or pivoted to one or more bracket components fixed or connected to the lower tube or to a respective closing component, and wherein the lever component delimits a connection through hole or opening having a first segment with a cross-section or encumbrance greater than a respective second segment, so that the cable passes through the whole through hole or opening, but the housing or sheath passes through the first segment, but is larger or greater than the second segment, and thus it abuts or hints the lever component at respective inner wall or parts deliming the second segment.

23. A bicycle having a frame, a seat or saddle and an adjustable height seatpost as claimed in claim 19, said frame including at least one tubular component with the lower tube of the adjustable height seatpost mounted therein, said seat or saddle being instead connected to said seat clamps or connector, said bicycle further including a handlebar as well as a remote lever or button control mounted thereon or on another component of the frame and suitable for controlling said adjustable height seatpost or rather said actuator mechanism,
the other or second or upper end of said cable being connected to said remote lever or button control, whereas the other end of said housing or sheath is mounted or connected to said handlebar or to another component of the frame of the bicycle.
